(19) United States
(12) Patent Application Publication
(10) Pub. No.: US 2008/0117619 A1
(43) Pub. Date: May 22, 2008

(54) Light source utilizing a flexible circuit carrier and flexible reflectors

(76) Inventors: Siew It Pang, Bayan Lepas (MY); Aizar Abdul Karim Norfidathul, Simpang Ampat (MY); Kheng Leng Tan, Bukit Jambul (MY); Tong Fatt Chew, Taman Sri Nibong (MY)

Correspondence Address: Kathy Manke;Avago Technologies Limited, 4380 Ziegler Road, Fort Collins, CO, 80525, US

(21) Appl. No.: 11/603,690

(22) Filed: Nov. 21, 2006

(51) Int. Cl. F21V 9/16; F21V 31/00; F21V 7/00

(52) U.S. Cl. 362/84; 362/267; 362/247

(57) ABSTRACT

A light source, a flexible circuit carrier and a flexible reflector are disclosed. The flexible circuit carrier includes a flexible substrate having a first surface having a plurality of electrical traces formed thereon. A first LED die is disposed on the first surface and connected to two of the electrical traces. A plurality of external electrical connections for accessing the electrical traces are also included in the circuit carrier. The flexible reflector includes a layer of flexible material having at least one cavity extending through the layer of flexible material. The flexible layer is bonded to the first surface such that the cavity overlies the first LED die. The cavity has walls that reflect light generated in the first LED die. The flexible material and the flexible substrate can include silicone.

### BACKGROUND OF THE INVENTION

Light emitting diodes (LEDs) are replacing conventional light sources such as florescent and incandescent light bulbs in many applications. LEDs have similar electrical efficiency and longer lifetimes than fluorescent light sources. In addition, the driving voltages needed are compatible with the battery power available on many portable devices.

To provide a replacement light source, however, light sources that utilize multiple LEDs are typically required. LEDs emit light in relatively narrow wavelength bands. Hence, to provide a light source of an arbitrary color, arrays of LEDs having different colors are often utilized.

In addition, to provide an LED light source of the intensity available from a conventional light source, multiple LEDs of each color must be included. The maximum light intensity from an LED is typically less than that available from an incandescent light of a few watts. Hence, to provide the equivalent of a 100-watt light bulb, a large number of low power LEDs must be combined in the replacement light source.

Light sources based on arrays of LEDs are typically constructed by attaching a number of packaged LEDs to a rigid printed circuit board (PCB). The LED dies typically emit a significant fraction of the light generated in the active layer of the LED out of the side of the die. To capture this light, the LEDs are typically placed in a rigid cup having reflective walls that redirect the light emitted from the sides of the die to the forward direction. In many designs, the cup is also filled with a clear encapsulant. The encapsulant protects the die from the environment. In addition, the encapsulant acts as a carrier for phosphors used to convert the light generated by the LED to light of a different spectrum.

In a co-pending patent application, U.S. Ser. No. 11/223,743, filed Sep. 8, 2005, a light source constructed on a flexible circuit carrier is described. In that light source, the PCB described above is replaced by a flexible circuit carrier that includes the electrical traces for powering the LEDs that are mounted on the flexible carrier. However, the embodiments that utilize reflectors still utilize rigid reflectors to redirect the light from the sides of the dies into the forward direction.

Some prior art reflector designs utilize a white plastic such as PPA or LCP that is metal coated to provide a reflective surface. Other designs utilize metal-coated ceramic. Still other designs utilize metal housing. The rigid reflectors are rigidly attached to a substrate or formed by molding or casting with the substrate. From a cost perspective, plastic reflectors have significant advantages over metal or ceramic reflectors.

Unfortunately, the reflectors must be able to withstand relatively high processing temperatures. AuSn eutectic die attachment can subject the package to temperatures as high as 320 degrees centigrade. PPA and LCP plastics have problems when subjected to these temperatures including degradation of the plastic or loss of reflectivity. In addition, these materials absorb moisture. The absorbed moisture can cause failures during moisture sensitive processes such as SMT reflow.

As noted above, the cups are typically filled with an encapsulant. For many applications, the preferred encapsulant is silicone because of the resistance of this material to degradation by light in ultraviolet or blue regions of the spectrum. Unfortunately, the plastic and metallic cups do not bond well to the silicone encapsulant. This is particularly problematic during temperature cycling as the silicone has a different coefficient of thermal expansion, and hence, tends to delaminate from the cup after multiple temperature cycles during operation.

### SUMMARY OF THE INVENTION

The present invention includes a light source having a flexible circuit carrier and a flexible reflector. The flexible circuit carrier includes a flexible substrate having a first surface having a plurality of electrical traces formed thereon. A first LED die is disposed on the first surface and connected to two of the electrical traces. A plurality of external electrical connections for accessing the electrical traces are also included in the circuit carrier. The flexible reflector includes a layer of flexible material having at least one cavity extending through the layer of flexible material. The flexible layer is bonded to the first surface such that the cavity overlies the first LED die. The cavity has walls that reflect light generated in the first LED die. The flexible material and the flexible substrate can include silicone.

### BRIEF DESCRIPTION OF THE DRAWINGS

FIG. 1 is a simplified top view of array 20.

FIG. 2 is a cross-sectional view of array 20 through line 2-2 shown in FIG. 1.

FIG. 3 is a cross-sectional view of a portion of a light source according to one embodiment of the present invention.

FIG. 4 is a cross-sectional view of light source 80 through line 4-4 shown in FIG. 5.

FIG. 5 is a top view of light source 80.

FIG. 6 is a cross-sectional view of a light source according to another embodiment of the present invention.

### DETAILED DESCRIPTION OF THE PREFERRED EMBODIMENTS OF THE INVENTION

The present invention utilizes a flexible cup structure to reduce the problems associated with differences in the thermal coefficient of expansion between the encapsulant material and the material from which the cups are constructed. In principle, the encapsulant is bonded both to the cups and to the underlying circuit carrier. All three of these materials can have different thermal coefficients of expansion. The present invention provides improved performance by utilizing a cup structure in which the cups are formed from voids in a molded layer of material that is sufficiently flexible at the operating temperatures in question to accommodate dimensional changes arising from temperature changes that are expected during the operation of the light source. Hence, differences in the thermal coefficient of expansion can be accommodated because the cup layer can flex to accommodate the change in dimensions of the encapsulant and/or underlying circuit carrier as the light source is subjected to temperature cycling associated with turning the LEDs on and off.

In addition, the present invention uses a flexible circuit carrier. The flexible circuit carrier can also flex to accommodate differential expansion of the components arising from differences in the thermal coefficient of expansion of the various components. In addition, in embodiments in which the flexible circuit carrier is applied to a non-planar surface or moves during the operation of the light source such that the circuit carrier bends, the flexible layer from which the cups are constructed can also bend to accommodate dimensional changes associated with the non-planar configuration,

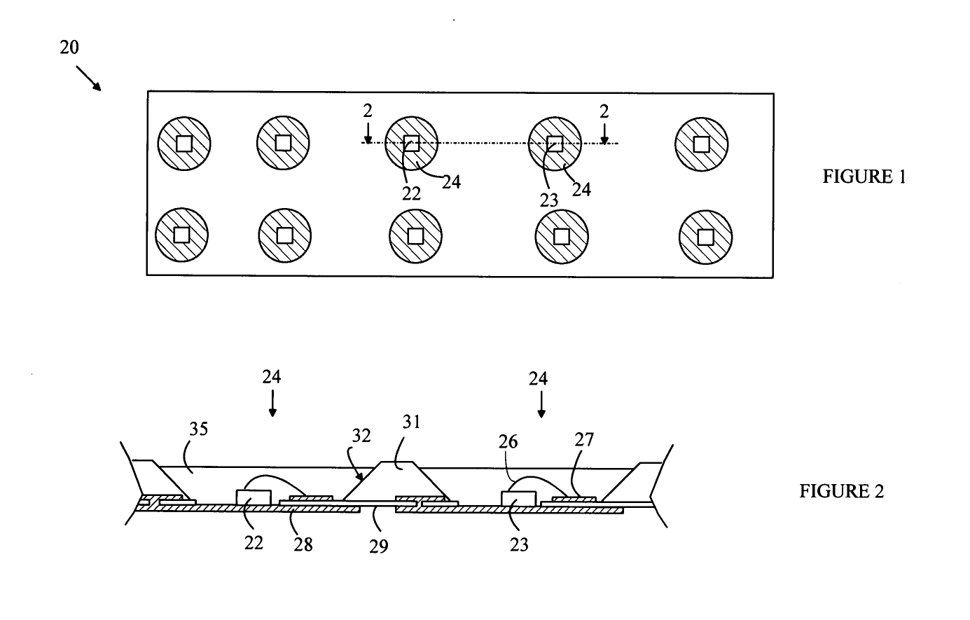

The manner in which the present invention provides its advantages can be more easily understood with reference to FIGS. 1 and 2, which illustrate a portion of a two-dimensional array of LEDs according to one embodiment of the present invention. FIG. 1 is a simplified top view of array 20, and FIG. 2 is a cross-sectional view of array 20 through line 2-2 shown in FIG. 1. Array 20 is constructed using a flexible circuit carrier. Array 20 is organized as a plurality of rows and columns; however, other arrangements of the LEDs can be utilized. Flexible printed circuit boards or circuit carriers are known to the art, and hence, will not be discussed in detail here. For the purposes of the present discussion it is sufficient to note that flexible circuit carriers can be fabricated by depositing thin metal layers, or attaching metal layers, on a flexible resin substrate 29 and then converting the layers into a plurality of individual conductors by conventional photolithographic techniques. Array 20 includes two such metallic layers. A bottom layer 28 acts as a heat sink in addition to providing a common electrical connection for the LEDs of array 20. Exemplary LED dies are shown at 22 and 23. The top layer is patterned to provide traces such as trace 27 that are used to connect the LEDs to other circuitry located on the flexible circuit carrier or on a separate substrate. The LEDs are connected to the traces using wire bonds such as bond 26. In the embodiment shown in FIGS. 1 and 2, the second connection to each LED is provided via the bottom of the LED die. To simplify the drawings, the circuit traces on the top surface of the flexible circuit carrier have been omitted from FIG. 1.

The LEDs can be bonded to the bottom conductive layer 28 using a heat-conducting adhesive or solder. Since the die is mounted directly on the heat-conducting layer, the present invention provides improved heat transfer relative to prepackaged LEDs. As will be explained in more detail below, the bottom surface of the flexible circuit carrier can be placed in thermal contact with a surface that moves the heat to a location at which the heat can be more efficiently moved to the ambient environment.

As noted above, the present invention provides reflective cups that redirect light that leaves the sides of the LED dies into the forward direction. The cups 24 are formed by voids in a reflector layer 31 constructed from a sheet of flexible material. The walls 32 of the cups are reflecting. The walls can be rendered reflecting by coating the walls with a reflective coating such as a metal layer of silver or chrome or by utilizing a flexible material that provides a white boundary layer at the cups. For example, a clear silicone material can be used for the flexible material. The TiO₂ particles can be suspended in the silicone prior to molding the sheet of material to form cup layer 31. Alternatively, a white “paint” can be used to coat the sides of the cups.

The dies are typically encapsulated in a clear encapsulant 35 that protects the dies from moisture. The encapsulant is also used in some embodiments as a carrier for phosphor particles that convert light emitted by the LED to light of a different spectrum. For example, in so-called “white” LEDs, the die consists of a blue LED. The encapsulant includes phosphor particles that convert part of the blue light to light in the yellow region of the spectrum. The combination of the yellow light and the remaining portion of the blue light is perceived as white by a human observer. The encapsulant may also include diffusing particles that scatter the light generated by the LED so that both the phosphor light and the remaining blue light appear to originate in the encapsulating material.

In the embodiment shown in FIGS. 1 and 2, the reflecting cups are filled with a clear encapsulant that is also flexible. For example, both the encapsulant and reflector layer 31 could be constructed from silicone. Such an arrangement minimizes the problems associated with the bonding of the encapsulant to the walls of the reflective cup. In addition, all the components can flex to accommodate dimensional changes associated with bending the light source to a configuration different from that in which the light source was assembled. It should also be noted that silicone is resistant to damage by blue and near UV light. In phosphor converted light sources, UV emitting LEDs are often used. Hence, a light source having a silicone encapsulant is particularly advantageous.

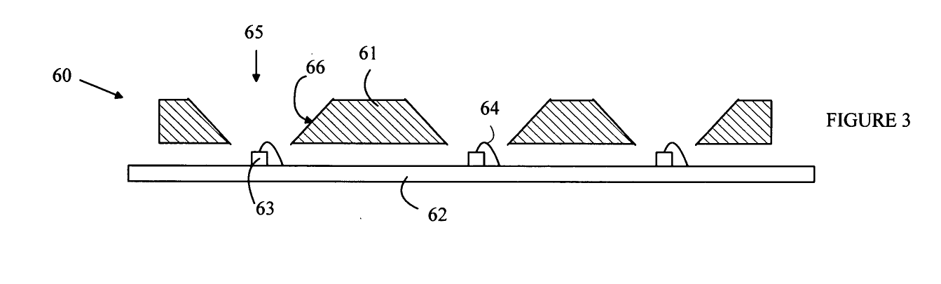

The reflector layer can be applied to the carrier as a separate component or molded in place on the carrier. Refer now to FIG. 3, which is a cross-sectional view of a portion of a light source according to one embodiment of the present invention. Light source 60 is constructed from a reflector layer 61 that is molded separately and then attached to circuit carrier 62. Reflector layer 61 is shown positioned with respect to circuit carrier 62 just prior to the bonding of the two components. Reflector layer 61 is molded from a flexible compound such as silicone and includes holes such as hole 65 having reflective walls 66. The LED dies 63 can be attached to circuit carrier 62 and electrically connected to circuit carrier 62 prior to the attachment of reflector layer 61. In the example shown in FIG. 3, the LEDs are connected to one trace that is under die 63 and one trace that is connected to that die by a wire bond such as wire bond 64. The reflector layer could be bonded to the circuit carrier by a silicone-based cement in this embodiment. After the reflector layer is bonded to circuit carrier 62, the reflective cups can be filled with the appropriate encapsulant.

The above embodiments utilize a silicone reflector layer. However, other materials can be utilized. For example, flexible circuit carriers constructed using polyamide insulating layers are available commercially from Dupont. In addition, layers of polyamide without the metal layers are also available from Dupont. These non-metalized layers are available with a thin layer of adhesive on one surface. These layers are normally used as cover layers for covering the top circuit traces on the circuit carrier. The reflector layer can be constructed by punching cone-shaped holes through such a cover sheet or by having a special cover sheet made with the holes molded into the cover sheet. The exposed surface could then be rendered reflective by applying a suitable metal coating. Finally, the cover layer would be positioned over the circuit carrier and bonded thereto such that the LED dies are located in the holes.

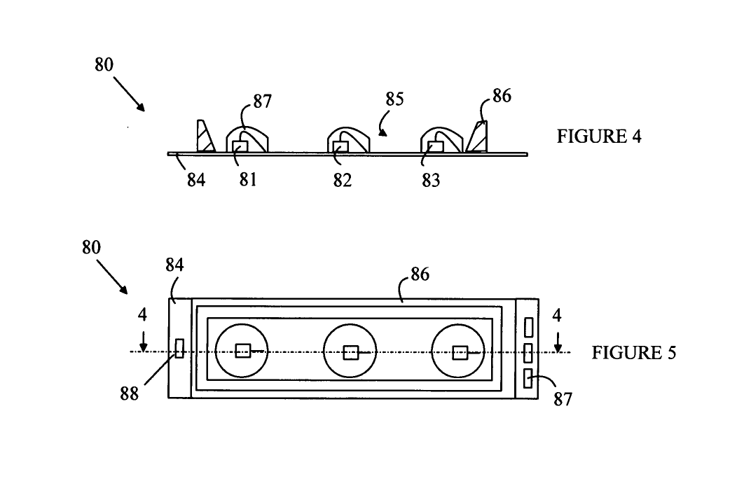

In the above-described embodiments of the present invention, each reflector housed one LED. However, embodiments in which multiple LEDs are located in a single reflector can also be constructed. Refer now to FIGS. 4 and 5, which illustrate a light source according to another embodiment of the present invention. FIG. 5 is a top view of light source 80, and FIG. 4 is a cross-sectional view of light source 80 through line 4-4 shown in FIG. 5. Light source 80 includes 3 LEDs 81-83 that share a single cavity 85 that is constructed from a cavity in layer 86. The LEDs are attached to a flexible circuit carrier 84 in a manner analogous to that discussed above. The conducting traces within circuit carrier 84 are accessed by external connectors 88. Each LED is individually encapsulated in an encapsulation layer 87; however, embodiments in which all of the LEDs are encapsulated in a single layer of encapsulant can also be constructed.

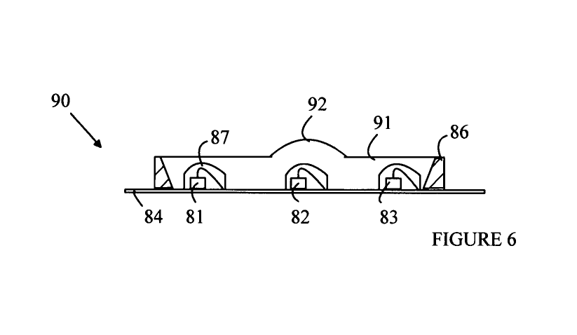

In addition, a two level encapsulation system could also be utilized. Refer now to FIG. 6, which is a cross-sectional view of a light source according to another embodiment of the present invention. Light source 90 differs from light source 80 in that the individual LEDs are encapsulated in a first encapsulant 87, and then, the cavity is filled with a second layer of encapsulant 91. Encapsulant layer 91 can also include optical processing elements such as lens 92 that are molded into encapsulant layer 91. It should also be noted that the individual encapsulant layers may differ in composition from LED to LED. For example, different encapsulation layers could include different phosphors such that the light generated by the different LEDs differs in spectrum from LED to LED. In one embodiment, both layers of encapsulant are constructed from transparent silicone.

The embodiments of the present invention described above utilize a phosphor conversion material to alter the output spectrum of the light from the light source. However, luminescent materials can also be utilized for this conversion function.

The above-described embodiments of the present invention utilize reflectors with reflective walls. For the purposes of this discussion, a reflector wall is defined as being reflective if that wall reflects more than 90 percent of the light generated in the LED or its fluorescent conversion layer.

The above-described embodiments utilize reflectors and circuit carriers made from flexible materials. For the purposes of this discussion, the layer of material having the cavities that become the reflectors will be defined as being flexible if the material can be bent to an angle of at least 45 degrees without damaging the light source.

If the encapsulant is clear and does not include a phosphor or scattering centers that diffuse the light, mirror-like reflectors can provide a light source that appears to be a point source in the far field. While a point light source has many desirable benefits including the ability to image or collimate the source, many useful LED designs provide an extended light source, and hence, the advantages of providing a mirrored surface are less significant. For example, embodiments that utilize phosphor to convert part, or all of, the light from the LED to light of a different spectrum, the light source that is being imaged in the far field appears to be the phosphor containing encapsulant and not a point source on the LED die. The phosphor compositions that are typically utilized in such phosphor-converted LEDs are typically suspended particles. The light striking the phosphor particles is either absorbed or scattered. The light in the new spectral region that is emitted by a phosphor particle originates in that particle; hence, the phosphor generated light appears to come from an extended light source having the same dimensions as the phosphor encapsulant. Even the unconverted light, after several scattering events, appears to come from the extended light source. In fact, many partially converted light sources, such as “white light” sources, include additional particles within the encapsulant to scatter the unconverted light so that the unconverted light appears to originate from the same extended source as the converted light.

In some embodiments, a partially converted light source is provided by utilizing a soluble phosphor in the encapsulant. If diffusing particles are not provided in the encapsulant, it is sometimes advantageous to include some other mechanism to diffuse the light that is not converted so that the two different spectrums of light will appear to originate in the same light source. Utilizing a reflector that has a matte finish can provide the diffusing function in such cases.

In addition to the phosphor materials discussed above, the encapsulation material could also include dyes or other materials that selectively absorb light in one or more wavelength bands to provide a modified output spectrum. The dyes could be utilized alone or in combination with phosphor converting materials.

Various modifications to the present invention will become apparent to those skilled in the art from the foregoing description and accompanying drawings. Accordingly, the present invention is to be limited solely by the scope of the following claims.

What is claimed is:

1. A light source comprising:
a flexible circuit carrier comprising a flexible substrate having a first surface having a plurality of electrical traces formed thereon; a first LED die is disposed on said first surface and connected to two of said electrical traces; and a plurality of external electrical connections for accessing said electrical traces; and
a flexible reflector comprising a layer of flexible material having at least one cavity extending through said layer of flexible material, said flexible layer being bonded to said first surface such that said cavity overlies said first LED die, said cavity having walls that reflect light generated in said first LED die.

2. The light source of claim 1 wherein said layer of flexible material comprises silicone.

3. The light source of claim 1 wherein said LED comprises a top surface, a bottom surface, and a plurality of side surfaces, said bottom surface being bonded to said flexible circuit carrier and wherein said cavity comprises a reflective wall that redirects light leaving a side surface of said LED into a direction parallel to light leaving said top surface of said LED.

4. The light source of claim 3 wherein said reflective wall comprises a metallic coating.

5. The light source of claim 1 wherein said flexible circuit carrier comprises a plurality of LEDs arranged in a two-dimensional array having a plurality of rows and columns.

6. The light source of claim 1 wherein said cavity comprises a layer of flexible encapsulant that covers said LED.

7. The light source of claim 1 wherein said flexible encapsulant comprises silicone.

8. The light source of claim 6 wherein said layer of encapsulant comprises a first layer of encapsulant adjacent to said first LED die and a second layer of encapsulant that overlies said first layer of encapsulant, wherein light emitted by said first LED die is characterized by a first spectrum and wherein said first layer of encapsulant comprises a luminescent conversion material that alters said first spectrum to create light of a second spectrum that exits said light source.

9. The light source of claim 6 wherein said layer of encapsulant comprises a first layer of encapsulant adjacent to said first LED die and a second layer of encapsulant that overlies said first layer of encapsulant, wherein light emitted by said first LED die is characterized by a first spectrum and wherein said second layer of encapsulant comprises a luminescent conversion material that alters said first spectrum to create light of a second spectrum that exits said light source.
